(19) United States
(12) Patent Application Publication
(10) Pub. No.: US 2010/0268585 A1
(43) Pub. Date: Oct. 21, 2010

(54) INJECTION ADVERTISING TECHNOLOGY

(75) Inventors: Stewart Padveen, Manhattan Beach, CA (US); Thomas E. Davis, Weston, FL (US); Aaron John Cody, Sausalito, CA (US); John Elery Danger Canty, Seattle, WA (US); Michael Richard Moore, Lighthouse Point, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Cloops, Inc., Manhattan Beach, CA (US)

(21) Appl. No.: 12/738,048

(22) PCT Filed: Oct. 17, 2008
(86) PCT No.: PCT/US08/80272

§ 371 Date: May 26, 2010

Related U.S. Application Data
(62) Division of application No. 11/874,635, filed on Oct. 18, 2007, now abandoned.

(51) Int. Cl. G06Q 30/00; G06F 15/16; G06F 9/445; G06Q 40/00

(52) U.S. Cl. 705/14.16; 709/206; 717/176; 709/219; 705/30; 705/14.66; 705/39

(57) ABSTRACT

A method and information processing system for providing messaging through an electronic messaging system. At least one user is determined to have performed at least one of the following two acts, creating an electronic message and sending an electronic message. At least one message is selected from a data store in response to the user having performed at least one of the two acts. The message is embedded within the electronic message. An accounting record is updated that includes information for compensating the user based on sent electronic messages including the message, which has been embedded.

### CROSS-REFERENCE TO RELATED APPLICATIONS

This application is a continuation-in-part and claims priority from U.S. patent application Ser. No. 11/874,635, filed on Oct. 18, 2007, the entire disclosure of which is herein incorporated by reference in its entirety.

### FIELD OF THE INVENTION

The present invention generally relates to the field of messaging, and more particularly relates to injecting into electronic messages, such as email and text messages, an additional message, such as ads, comprising a degree of relevancy to the sender.

### BACKGROUND OF THE INVENTION

Advertising on the Internet provides businesses with an inexpensive and efficient way of reaching a vast audience. One form of Internet advertising is Spam, which is unsolicited email messages sent out in bulk. Spamming is very controversial and often reviled by most recipients. In fact, most email systems block Spam messages, thereby making this form of advertising very inefficient.

Another type of Internet advertising is based on banner ads or pop-up ads. These ads are usually randomly generated and generally comprise minimal direct relevance to the user. Banner ads and pop-up ads are not always targeted to a viewer, but when they are traffic patterns are used for targeting ads as compared to information associated with the individual.

Search Engine cost-per-click (“CPC”) ads are yet another form of ads used on the Internet. Cost-per-click ads do provide some degree of relevance matching, but are based on a keyword bidding system. This often allows many advertisers to vie for the same keyword, giving results only to the top bidder. This process has priced many small companies out of the CPC market.

Email messages and emailing environments such as a web-based email client are starting to be used as an efficient medium for ads. Most free, web-based email providers include their own ads within emails or email environments. However, these ads are generally not relevant to the sender of the email or the recipient. Google's Gmail is one example of an email system that includes ads within a web-based email environment. In other words, Gmail displays ads to a user viewing an email within the web page used to view the email One problem with Google's approach is that ads are based on the information within the message, which may or may not be relevant to the sender, and information relevant to the reader. Another problem with Google's approach is that the sender is not compensated for ads being associated with a message that is sent to or viewed by a recipient.

Still, another problem is how to embedded messages and advertisements on web browser-based email systems. Unless the message is appended at the email server, the message must be appended at the client web-browser. Many providers of browse-based email systems do not allow third parties to interface with their server software. Instead a third party must work with the web-browser itself. Most web-browsers employ security “sandbox” around scripts such as Javascript codes. This prohibits adding advertisement to web-based email messages.

Therefore a need exists to overcome the problems with the prior art as discussed above.

### SUMMARY OF THE INVENTION

Briefly, in accordance with various embodiments of the present invention, disclosed is a method at a client system for providing messaging through an electronic messaging system. At least one user is determined to have performed at least one of the following two acts, creating an electronic message and sending an electronic message. At least one message is selected from a data store in response to the user having performed at least one of the two acts. The message is embedded within the electronic message. An accounting record is updated that includes information for compensating the user based on sent electronic messages including the message, which has been embedded.

In another embodiment, a method at a server system for providing third-party messages in electronic messages is disclosed. The method includes analyzing a profile associated with a user. Information within the profile is compared to a set of target user requirements associated with a plurality of third-party messages. At least one third-party message in the plurality of third-party messages is associated with the user in response to at least one target user requirement associated with the third-party message substantially matching information within the profile. An account associated with the user for compensating the user is credited in response to a client system associated with the user utilizing the third-party message that has been associated with the user.

In yet another embodiment, an information processing system for providing messaging through an electronic messaging system is disclosed. The information processing system includes a processor and a memory that is communicatively coupled to the processor. The information processing system also includes an injection advertising client that is communicatively coupled to the processor and memory. The injection advertising client is adapted to determine that a user has performed at least one of the following two acts, creating an electronic message and sending an electronic message. At least one message is selected from a data store in response to the user having performed at least one of the two acts. The message is embedded within the electronic message. An accounting record is updated that includes information for compensating the user based on sent electronic messages including the message, which has been embedded.

One advantage of the present invention is that advertisers can efficiently and effectively advertise their products and services within an electronic message. Advertisers are able to create their own text and hyperlinked ads and select the geographic location, demographic information, and the like to which they want to match their ads for injection within an email message. Users can subscribe to the injection advertising system for sending emails with embedded messages or ads and also be compensated for doing so. Another advantage of the embodiments of the present invention is that the messages or ads that are embedded within an electronic message are selected by the injection advertising system based on user-subscriber data and advertiser data Therefore, an ad or message embedded within an email message or any electronic messages comprises a degree of relevancy with respect to the sender. Accordingly, because senders of an email message and recipients of the message generally have common interests, the message(s) or ad(s) embedded within the email are likely to also be relevant to the recipient as well. Another advantage is that because of the ad is injected within an electronic message spam filters are not likely to flag the message.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating an exemplary system according to an embodiment of the present invention;

FIG. 2 is a block diagram illustrating an exemplary electronic message including an injected third-party message according to an embodiment of the present invention;

FIG. 3 is a block diagram illustrating and exemplary information processing system environment according to an embodiment of the present invention;

FIG. 4 is an operational flow diagram illustrating a process of a user subscribing to an injection advertisement system according to an embodiment of the present invention;

FIG. 5 is an operational flow diagram illustrating a process of injecting a third-party message in to an electronic message that is relevant to the sender of the message according to an embodiment of the present invention;

FIG. 6 is an operational flow diagram illustrating a process of detecting selecting third-party messages to send to a user-subscriber according to an embodiment of the present invention;

FIG. 7 is an operational flow diagram illustrating a process updating accounting information associated with a user when a recipient of a message selects and embedded third-party message according to an embodiment of the present invention; and

FIG. 8 is an operational flow diagram illustrating an overall process overall process for providing an embedded third-party message within an electronic message according to an embodiment of the present invention.

FIG. 9 is an example of the over-all plug-in architecture for an Internet Explorer web-browser, according to an embodiment of the present invention.

FIG. 10 is an example of the over-all plug-in architecture for a Firefox web-browser, according to an embodiment of the present invention.

FIG. 11 is a generalized flow of the web page monitoring used in the web-based email systems, according to an embodiment of the present invention.

FIG. 12 is a generalized flow of the web page embedding used in the web-based email systems, according to an embodiment of the present invention.

FIG. 13 is an example flow of message or code injection in a first phase of execution, according to the present invention.

FIG. 14 is an example flow of message or code injection in a second phase of execution, according to the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Further, the term third-party message is used herein to define any additional information such as an ad (advertisement), slogan, news blurb, and the like attached to or embedded within a primary electronic message such as an email electronic message, text message, multi-media message, and the like. A third party message can comprise text, video, audio, still images, or a combination thereof The terms inject, append, embed, and similar terms are used herein to define an action of placing a third party message or default message anywhere within an electronic message.

### Exemplary System

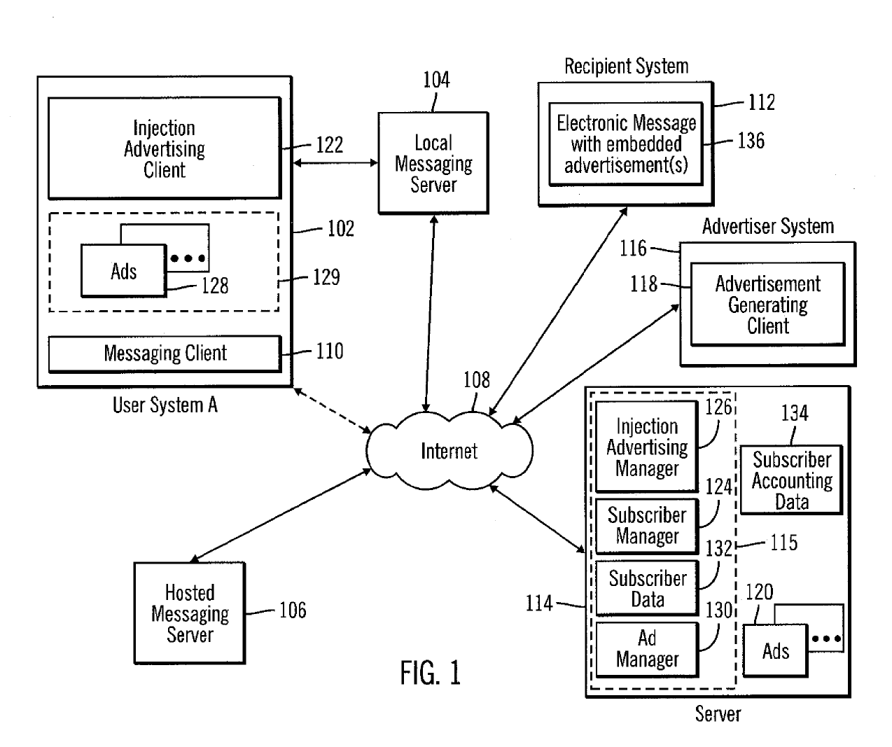

FIG. 1 is a block diagram illustrating an exemplary system 100 for injecting third party messages such as an ad into electronic messages according to an embodiment of the present invention. It should be noted that throughout the following discussion an ad is used as one example of a third-party message. It should also be noted that a third-party message can comprise text, video, still images, or a combination thereof.

In particular, the system 100 of FIG. 1 matches a sender of an electronic message with one or more ads for injecting the ad within the message. The ads, in one embodiment, are selected based on information associated with the sender. Therefore, the selected ads comprise a degree of relevancy corresponding to the sender. The system 100 of FIG. 1 further provides monetary and/or non-monetary compensation to each sender associated with an electronic message comprising an injected ad(s).

FIG. 1 shows one or more user systems 102 communicatively coupled to one or more messaging servers 104, 106. A user system can include a wireless device (e.g., a cellular telephone, a mobile phone, a smartphone and other wireless communication devices), a laptop/computer, a desktop computer, and other information processing systems.

A messaging server 104, 106 can be an email server, Short Message Service (“SMS”) server, a Multimedia Message Server (“MMS”), instant messaging service server, and other messaging servers. In one embodiment, the user system 102 is communicatively coupled to a local messaging server 104 such as a home email server, a company email server, or the like. In another embodiment, the user system 102 is communicatively coupled to a hosted message server 106 such as Google, Yahoo, AOL, MSN, Hotmail, or the like via the Internet 108. A user at the user system 102 creates an electronic message such as an electronic message or email message via a local messaging client 110 or a web interface client destined for reception by a recipient system 112. It should be noted that the terms “user”, “user-sender”, and “sender” used throughout this discussion refer to a user at a user system 102 who sends an electronic message.

FIG. 1 also shows one or more servers 114 for hosting an injection advertising system 115. In one embodiment, advertisers, via an information processing system 116, communicate with the injection advertising server 114 for creating ads 120 to be injected into electronic messages. In one embodiment, advertisers can create ads via a web interface at the injection advertising server 114 or can use a local ad generating client 118 communicatively coupled to the injection advertising server 114 via the Internet 108. Alternatively, an advertiser can upload its own ads to the injection advertising server 114. In one embodiment, the ads created by an advertiser are filtered to ensure the contents of the ads meet the criteria of the injection advertising system 115. The filtering can be performed either automatically and/or manually by one or more humans. During the ad creation process, advertisers can create text ads, hyperlink ads, image ads, audio ads, and other types of ads. Each of these ads 120 can be associated with (but not limited to) demographics, location, categories, and keywords. This data is used by the injection advertising system 115 to match an ad 120 with a relevant user-sender subscribing to the system 115.

The following is one example of how a user-sender can subscribe to the injection advertising system 115. It should be noted that this is only one example and does not limit the present invention in any way. A user can download an injection advertising client 122 from the electronic message or email advertising server 102. Once the injection advertising client 122 is installed on the user-sender system (or during installation); the user enters his/her email address into the injection advertising client 122.

The user's email address is sent to the injection advertising system 115 for subscription purposes. For example, a unique identifier can be associated with the user by the injection advertising system 115 based on the email address. The unique identifier allows a subscriber manager 124 at the injection advertising system 115 to uniquely identify and monitor each subscriber. The email address can also be used by the injection advertising system 115 to send a registration link to the user. This link allows a user to complete the registration process. For example, a user at a registration page is prompted to enter information such as name, address, contact information, and other information that the injection advertising system 115 can use for paying/tracking a subscribing user earned commissions, as discussed in greater detail below.

The user is also prompted to enter other information such as date of birth, gender, annual income, keywords which describe the user, user interests, hobbies, jobs, daily activities, and the like. This information is used by an ad manager 130 in the injection advertising system 115 to match relevant ads 120 to the user. In one embodiment, the ad manager 130 compares advertiser key words, target gender, age, income, location, and the like with user entered information to determine the relevant ads. This is advantageous because the ads 128 sent to user are not random and irrelevant; they comprise a degree of relevancy to the user-sender. In one embodiment, the ads sent to the user system 102 are text-based hyperlinks and do not comprise graphics to prevent spam filters from flagging the email. However, other embodiments of the present invention do utilize graphical ads. It should be noted that the injection advertising client 122 allows the user to update his/her subscriber data/profile 132 such as email address and ad relevant information at the injection advertising system 115.

Injection of Ads into an Electronic Message

Once the injection advertising client 122 has been installed at the user system 102, a user can begin sending electronic messages comprising injected ads. The injection advertising client 122 can be installed onto the user system 102, in one embodiment, by downloading the injection advertising client 122 from the server 114, installing from a removable media such as a CD or DVD, and the like. In one example, the user-sender subscribes to the injection advertising system 115 as do businesses that create the third-party messages. Therefore, these messages created by the business are third-party messages with respect to the user-sender. As stated above, an ad is used throughout the following discussion as one example of a third-party message. The injection advertising client 122, in one embodiment, can be a stand alone program, a plug-in for a messaging client 110, web-based for use with web-based email systems, and the like. In an embodiment that uses web-based email. The injection advertising client 122 can be a plug-in for the web-browser.

It should be noted that the user has the option to turn the injection advertising client 122 on/off or select which electronic messages are to include an injected third-party message. In one embodiment, the user creates an electronic message via the electronic messaging client 110 (or a web interface to a messaging system) such as Microsoft Outlook, Microsoft Outlook Express, Gmail, Hotmail, Yahoo Mail, AOL Mail, Facebook, MySpace, and the like. The user then enters one or more recipients, subject, body, attachments, and the like. It should be noted that the user then proceeds to send the message to the recipients by selecting the appropriate widget, pressing a key, entering a key sequence, and the like. A widget, in one embodiment, is a Graphical User Interface (“GUI”) element that is configured to allow a user to interact with an application and/or operating system in a particular way.

The injection advertising client 122, in one embodiment, detects that the user is sending a message and retrieves a third-party message 128 from a message archive 129, which comprises third-party message and defaults messages. As discussed above, these messages are pre-fetched from the injection advertising system 115 and stored locally, which allows the messages to be injected even if the user system 102 is off-line. The third-party message 128 is then injected/embedded into the electronic message after a “send” action is performed by the user. It should be noted that the third-party message 128 can also be injected into the message when the “compose” option is selected in the electronic messaging client 110 or at any other point prior to sending the electronic message.

The injection advertising client 122 locally embeds the third-party message 128 within the electronic message as compared to a direct population from the message server 104, 106 or the injection advertising system 115. This prevents any lag or delay occurring when sending the message. However, other embodiments of the present invention inject the third-party message 128 at the message server 104, 106 or the injection advertising system 115. For instance the present invention in one embodiment embeds messages at the server for browser-based email site such as Google or Yahoo or at a social networking site such as Facebook and LinkedIn. This provides a quick deployment for publishers of electronic messages and advertisements.

It should be noted that the third-party messages 128 can also reside on a remote information processing system as well. It should be noted that the third-party messages 128 can be injected/embedded at any location within the electronic message.

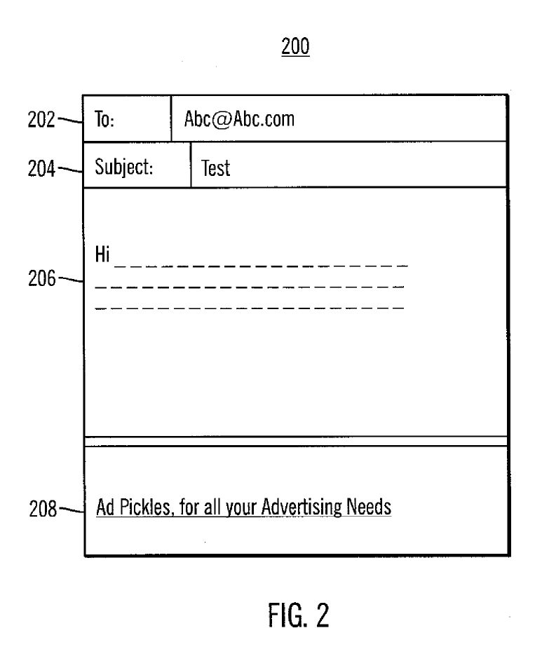

FIG. 2 shows one example of an electronic message 200 with an injected third-party message 128 such as an ad. In particular, FIG. 2 shows an email message 200 comprising a recipient email address 202 of ABC@ABC.com and a subject field 204 including the subject “Test”. The email message 200 also includes a body section 206 comprising a message. When a user sends this message 200 or when the message is initially created an ad 208 is injected into the message 208. In the example of FIG. 2, the user entered subscriber data 132 at the injection advertising system 115 that indicates the subscriber has an interest in ads or marketing (e.g., job information, hobbies, or the like). Therefore, the ad 208 entered into the email message 200 corresponds to advertising or marketing. It should be noted that other user information such as location, age, and the like can also be used by the injection advertising system 115 for selecting an ad to associate with the sender.

The ad 208, in one embodiment, was injected into email message 208 by the injection advertising client 122. For example, the injection advertising client 122 retrieved the ad 128 from the message archive 129 and embeds the message into the email 200. If the user-subscriber has disabled the injection advertising client 122 or does not have a third-party message available in the message archive 129, a default ad, message, or the like that is not limited to a third-party message can be injected in the message.

Returning back to FIG. 1, once the electronic message with an injected third-party message has been sent, the injection advertising client 122 communicates with the injection advertising system 115 to repopulate the message archive 129 with another message 128. In this embodiment, the message archive 129 is a data store or ad inventory. Having a local archive of messages helps minimize user delay that would otherwise occur if the server needed to inject an ad directly into an e-electronic message at the time of sending. In other words, if the injection advertising client 122 needs to poll the injection advertising system 115 for a third-party message every time an electronic message is sent, the user could potentially experience a delay after the user transmits the electronic message. In one embodiment, the injection advertising client 122 queries a URL associated with a location where the injection advertising client 122 can download the third-party messages 128 in the message archive/data store 129.

In one embodiment, the message archive 129 can be a stamp book or a dynamic file such as is a mark-up language file such as an XML file that is asynchronously loaded with third-party message 128. The polling intervals or rules can be defined as desired. In one embodiment, when the injection advertising client 122 is installed at the user system 102, a predefined number of third-party messages 128 are placed into the message archive 129. It should be noted that the initial third-party messages 128 can be downloaded before or after the user registers with the injection advertising system 115. However, in one embodiment, a user is not compensated for sending electronic messages with injected third-party messages 128 until the user subscribes with the injection advertising system 115.

If the number of third-party messages 128 in the stamp book 129 falls below a given threshold, the injection advertising client 122 downloads enough third-party messages 128 to get the stamp book above or equal the given threshold. It should be noted that the injection advertising system 115 can also periodically poll the injection advertising client 122 to determine if the number of third-party messages 128 are below the given threshold. As discussed above, the third-party messages 128 that are sent to the user-subscriber are relevant to the user-subscriber. In other words, the third-party messages 128 are selected based on advertisers requirements and subscriber data 132 entered by the selected by the third-party message manager 130 based on the information.

In addition performing a pull operation for repopulating the message archive 129 a push operation can be performed by the injection advertising system 115. For example, the injection advertising client 122 can notify the injection advertising system 115 that the user-subscriber has sent a message with an injected third-party message. The injection advertising system 115 then sends a pre-selected third-party message that is relevant to the user to the injection advertising client 122. The injection advertising client 122 then stores the received messages in the message archive 129.

The injection message manager 126, in one embodiment, updates subscriber accounting data 134 corresponding to the user for monitoring how many electronic messages a user-subscriber has sent with an injected third-party message. In one embodiment, the injection advertising client 122 can notify the injection advertising system 115 once the user-sender sends a message with an injected third-party message. In another embodiment, the injection advertising system 115 maintains a count of how many third-party messages 128 are sent to the message archive 129 for determining how many electronic message a user-subscriber has sent with injected third-party messages 128.

The messages comprising third-party messages 128 are tracked because the user-subscriber is compensated for utilizing a third-party message. Utilization can encompass (but is not limited to) a third-party message being sent to or retrieved by the user system 102 associated with the user, a third-party message being stored in the message archive 129, an electronic message being injected with the third-party message, and an electronic message being sent with an injected third-party message.

This compensation can be monetary based on, for example, a percentage of each third-party message that is sent or non-monetary such as discounts, free merchandise, and the like. A user-subscriber can log-in to his/her account at the injection advertising server 114 to review earnings made. Payouts can be performed for each message transaction, after a threshold of earnings has been met, or the like. In another embodiment, the user-subscriber can be awarded additional compensation each time a recipient at a recipient system 112 selects or views a third-party message within a received message 136.

In this embodiment, each of the injected third party messages 128 comprises a hyperlink to an ad residing at the server 114. When a recipient selects the third-party message 128 the server detects a hit at the server 114 for the ad and updates the user-sender's account data 134 accordingly. It should be noted that in one embodiment, a user-subscriber is only compensated for third-party messages that have been paid for. In other words, messages not paid for by advertisers such as default messages are not compensated. However, other embodiments of the present invention are not limited to this example.

It should be noted that in one embodiment, the injection advertising system 115 maintains a total count of advertisements that are associated with an advertiser. Each time an ad is sent to or retrieved by the user system 102, the total ad count associated with the respective advertiser is decremented. This can be used for statistical purposes and/or accounting purposes. For example, an advertisement can pay for a block of ads or pay on a per ad basis. In one example, when the block of ads are depleted (e.g., the total count is equal to 0) the advertiser is required to purchase another block of ads. It is important to note that in another embodiment the balances were adjusted based on the messaging 110 continually polling the balance of the local cache or stampbook and adjusting that as necessary, which operation is technically independent from the injection process.

In another embodiment, a user-subscriber can also be compensated for referring the injection advertising service to another user. For example, the user-subscriber can be further compensated every time a referral subscribes to the injection advertising system 115. The user-subscriber can even further compensated each time a referred user-subscriber sends an electronic message injected with a third-party message. Even further compensation can be awarded to the user-subscriber when a recipient of a message injected with a third-party message sent by a referred user selects or views the message.

It should be noted that although the above discussion uses email services in one example, the embodiments of the present invention are also applicable to other messaging systems as well. For example, a corporation can be an “advertiser” subscriber of the injection advertisement system. The corporation can have an injection client 122 installed on their servers that inject, slogans, or the like into electronic messages sent by their employees. In one embodiment, each employee can have an injection advertising client and third-party messages are selected based on an employee's profile. In another embodiment, third-party messages can be selected based on a corporation's profile. The corporation in this embodiment can also be a business that provides a specific service to its customers such as a global community. In this embodiment, the business's servers have the injection advertising client 122 installed. The injection advertising client 122 injects third-party messages 128 selected based on the service-subscriber's profile setup when they joined the service. Compensation in both of these examples is similar to that which has already been discussed above.

As can be seen from the above discussion, embodiments of the present invention are advantageous because they provide an efficient and effective system for providing third-party messages 128 within an electronic message. Advertisers are able to create their own text and hyperlinked third-party messages and select the geographic location, demographic information, and the like to which they want to match their third-party messages. Users can subscribe to the injection advertising system for sending electronic messages with embedded third-party messages 128 and being compensated for doing so. Another advantage of the embodiments of the present invention is that the third-party messages 128 embedded within an electronic message are selected by the injection advertising system based on user-subscriber data 132 and advertiser data Therefore, a third-party message embedded within an electronic message comprises a degree of relevancy with respect to the sender. Accordingly, because senders of an electronic message and recipients of the message generally have common interests, the third-party message(s) embedded within the electronic message are likely to also be relevant to the recipient as well. Another advantage is that because the third-party message is configured within an electronic message, spam filters are not likely to flag the message.

It should be noted that the present invention is also applicable to corporate or service provider environments such as MySpace and Facebook. The present invention is also applicable to instant messaging, blogs, forums, newsgroups, feed readers, advertising technologies/services, and the like. For example, embodiments of the present invention can be integrated with a third-party web site that has an email system or instant messaging system, Short Message Service (“SMS”) server, a Multimedia Message Server (“MMS”), and other messaging servers allowing the web site to provide the benefits of to their users and/or customers.

Injection Advertising Client

The following is a more detailed discussion on the injection advertising client 122. It should be noted that the following discussion is only one way of implementing the injection advertising client and does not limit the present invention in any way. The injection advertising client 122, in on embodiment, is a collection of software components that run locally on the user system 102. The injection advertising client 122 injects arbitrary HTML/text strings into their outgoing electronic messages such as email message with the consent of the user. The techniques used to achieve this vary considerably depending on the messaging client software in question. However, all plug-ins share common functionality provided by a centralized service or centralized tray application.

The centralized tray application, in one embodiment, is a module that runs continuously on the user system 102 and is responsible for two things. First, the centralized tray application retrieves messages such as ads from the server 114 and maintains them locally in an XML file (e.g., the message archive 129). Second, the centralized application tray manages user preferences such as the email address used to identify the injection advertising client 122 to the injection advertising system 115.

The concept of the message archive 129 is important for various reasons. Firstly, it allows stamping (injection of messages such as ads) to work when the user is offline. Secondly, it provides a better user experience should there be lengthy network/http delays during retrieval. As stamps are consumed, new ones are automatically retrieved and added to the message archive 129. If all stamps are used up and new ones are unavailable for some reason (e.g. the user is offline for a long period of time), then a default message is used instead. On Microsoft Windows systems, the centralized tray application can be implemented as a C++ tray application. On Mac OS X systems the centralized tray application can be implemented as an Objective-C Cocoa application.

Within a Microsoft Outlook environment, the injection advertising client 122 can be implemented as an add-in DLL, implemented in C++. The injection advertising client 122 is loaded every time Outlook launches and monitors certain events, such as connection/disconnection and email sent. The injection advertising client 122 uses the Microsoft Outlook OLE Automation interfaces to performing its functions such as intercepting an outgoing message body and inject/embed an ad (from the local message archive 129).

Within a Microsoft Outlook Express or Microsoft Windows Mail environment, the injection advertising client 122, in one embodiment, is implemented using a third-party toolkit such as a toolkit from Nektra, to perform the same function as Microsoft Outlook.

Within a web-based environment such as Yahoo!, Gmail, AOL, and Hotmail, the injection advertising client 122 is hosted within a web-browser environment such as Microsoft Internet Explorer and implemented in JavaScript. The problem of injecting performed by these types of clients is the increased complexity due to the tight security “sandbox” that the browser places around the JavaScript code. The notion of ‘code injection’ comes into play here. Currently, API's do not exist for allowing the injection advertising client 122 to interact within a “sand-box” environment.

Therefore, in one embodiment, a standard BHO (Browser Helper Object) DLL is implemented in C++ (or any other object oriented programming language). This BHO DLL is loaded by the web-browser when it starts up. The BHO then hooks into various low-level events, such as connection/disconnection and document load. The document load event gives access to the JavaScript DOM object that corresponds to the page that the browser is loading. Other important information such as the source URL of the loading document is also obtained. Using this, it can be determined if the current page is to be injected into or not. To accomplish this, an XML file of “patterns” is maintained, which are basically fragments of source URLs and unique JavaScript code on the particular pages of interest. Each time a page loads, pattern file is scanned for a match and if found, the injection process proceeds. Otherwise the page is left untouched.

In one embodiment, the pattern file also includes URL's to JavaScripts that are stored on server 114. This is the actual JavaScript to be injected. The JavaScript is kept on the server side to ease maintainability. The items injected into the page are the messages such as ads (retrieved from the local message archive 129) and a <SCRIPT> block that references the corresponding JavaScript file at the server 114. JavaScripts for each web-based email client can be maintained and are hand-tailored to a particular site.

After constructing the <SCRIPT> blocks for injection, using standard C++ DOM APIs, the live DOM object is obtained for the target page via the pageload event. The new DOM nodes are then appended to the end of that and the web-browser executes them. This process is referred to as live code injection. The JavaScript files that are injected can follow a common format. First the files declare two string stamp variables, one in HTML format, and another in plain text format. Next, a function is declared that searches the document for the email ‘SEND’ button(s). If found, an “onclick” event is attached to them. The handler for this event is a second function, which searches for the BODY element of the email compose field, obtains the content and embeds an ad. The handler also detects the mode of the outgoing message (HTML or plain text) and embeds the ad accordingly.

The net result is that the outgoing ad is embedded into the email and the whole user experience is as transparent as using an email client such as Microsoft Outlook in the conventional manner As stated above, each JavaScript file that is injected is specific to a particular website (e.g., Yahoo!, Gmail, and other). As many sites as needed can be supported by adding new entries to the XML pattern file. Each time the web-browser launches, it checks for an updated pattern file, so that injection advertising client 122 is always up to date.

Mozilla Firefox is another example of a web-browser. In this example, a standard Firefox extension is implemented in JavaScript, as defined by the Mozilla API. The extension allows various embodiments of the present invention to “hook” into the JavaScript of any particular web page and install event listeners for page-load. The URL of the page that is loading can be determined, thereby allowing, the XML pattern file to be used for determining whether or not to proceed with to code injection. In order to inject an ad into the page, the JavaScript security sandbox needs to be overcome.

Insecure practices such as HTTP calls to the server 114 and accessing the local file system are not used. Therefore, an XPCOM component is used instead. This is a component defined by the Mozilla APIs that allows various embodiments of the present invention to go “under the hood” of the JavaScript sandbox. The XPCOM component is implemented as a C++ DLL and is responsible for accessing the local message archive 129 as before, retrieving and returning a string ad to the JavaScript executing up in the browser. Using the methods implemented on the XPCOM object, the above discussed process such as hooking into the SEND buttons, locating the BODY text of the outgoing message, and retrieving and injecting an ad via the XPCOM object can proceed. This is a far more dynamic and extensible approach than ever seen before with other code-injection software, such as Greasemonkey, which only allows the injection of static pre-defined fragments of HTML.

Exemplary Information Processing System

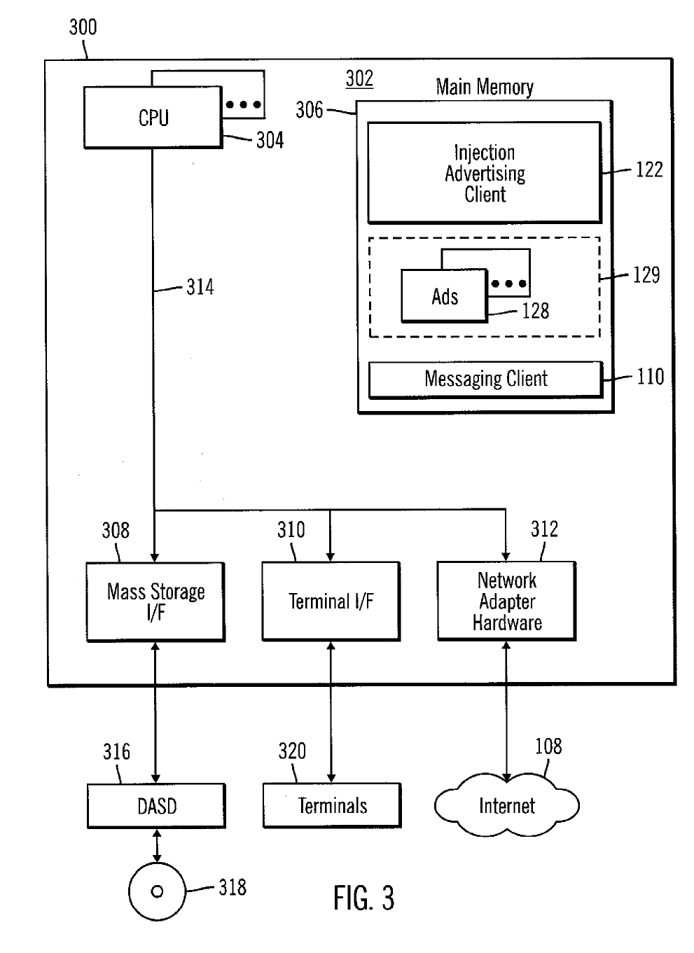

FIG. 3 is a block diagram illustrating a more detailed view of an information processing system 300 according to an embodiment of the present invention. The information processing system 300 of the following discussion is with respect to the user system 102. However, the following discussion is also applicable to other information processing systems such as the injection advertising server 114. The differences are one or more components residing within the memory 306. The information processing system 300 is based upon a suitably configured processing system adapted to implement the exemplary embodiment of the present invention. Any suitably configured processing system is similarly able to be used as the information processing system 300 by embodiments of the present invention.

The information processing system 300 includes a computer 302. The computer 302 has a processor 304 that is connected to a main memory 306, mass storage interface 308, terminal interface 310, and network adapter hardware 312. A system bus 314 interconnects these system components. The mass storage interface 308 is used to connect mass storage devices, such as data storage device 316, to the information processing system 300. One specific type of data storage device is a computer readable medium such as a CD 318 or DVD. Another type of data storage device is a data storage device configured to support, for example, NTFS type file system operations.

The main memory 306, in one embodiment, comprises the injection advertising client 110, message archive 129 with third-party messages 128, and an optional electronic messaging client 110. Although illustrated as concurrently resident in the main memory 306, it is clear that respective components of the main memory 306 are not required to be completely resident in the main memory 306 at all times or even at the same time. In one embodiment, the information processing system 300 utilizes conventional virtual addressing mechanisms to allow programs to behave as if they have access to a large, single storage entity, referred to herein as a computer system memory, instead of access to multiple, smaller storage entities such as the main memory 306 and data storage device 316. Note that the term “computer system memory” is used herein to generically refer to the entire virtual memory of the information processing system 300.

Although only one CPU 304 is illustrated for computer 302, computer systems with multiple CPUs can be used equally effectively. Embodiments of the present invention further incorporate interfaces that each includes separate, fully programmed microprocessors that are used to off-load processing from the CPU 304. Terminal interface 310 is used to directly connect one or more terminals 320 to computer 302 to provide a user interface to the computer 302. These terminals 320, which are able to be non-intelligent or fully programmable workstations, are used to allow system administrators and users to communicate with the information processing system 300. The terminal 320 is also able to consist of user interface and peripheral devices that are connected to computer 302 and controlled by terminal interface hardware included in the terminal I/F 310 that includes video adapters and interfaces for keyboards, pointing devices, and the like.

An operating system (not shown) included in the main memory is a suitable multitasking operating system such as the Linux, UNIX, Windows XP, Windows Server operating system, Mac operating system, and the like. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 300. The network adapter hardware 312 is used to provide an interface to a network such as the Internet 108. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via CD or DVD, e.g. CD 318, CD ROM, or other form of recordable media, or via any type of electronic transmission mechanism.

Exemplary Process Of User Subscription

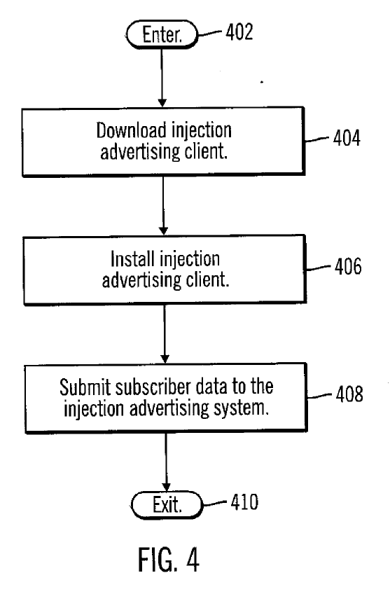

FIG. 4 is an operational flow diagram illustrating one example of a user subscribing to the injection advertisement system 115. The operational flow diagram of FIG. 4 begins at step 402 and flows directly to step 404. The user, at step 404, downloads the injection advertising client 122. For example, the user visits a website hosted at the server 114 and selects an option to download the injection advertising client 122. Alternatively, the user can also receive the injection advertising client 122 as an electronic message attachment, on a removable medium such as a CD, DVD, flash drive, and the like. The user, at step 406, installs the injection advertising client 122. Once the injection advertising client 122 is installed it can pre-fetch third-party messages 128 to populate the message archive 129 as discussed above. In other words, the injection email advertising system 115 matches third-party messages to a user-subscriber and the injection advertising client 122 pre-fetches one or more of these messages. The pre-fetching and local storage of messages allows the third-party messages 128 to reside locally and be injected into an electronic message even if the user system is off-line.

However, in one embodiment, the third-party messages are not relevant to the user-subscriber until the user-subscriber registers (step 408) with the injection advertising system 115. The user, at step 408, submits subscriber data 132 to the injection ad system 114. For example, the user submits his/her name, address, contact information, and other information that the injection advertisement system 115 can use for paying the user earned commissions. The user also submits additional information such as date of birth, gender, annual income, keywords which describe the user, user interests, hobbies, jobs, daily activities, and the like. The control flow then exits at step 410.

Exemplary Process of Injecting an Third-Party Message(s) into an Electronic Message

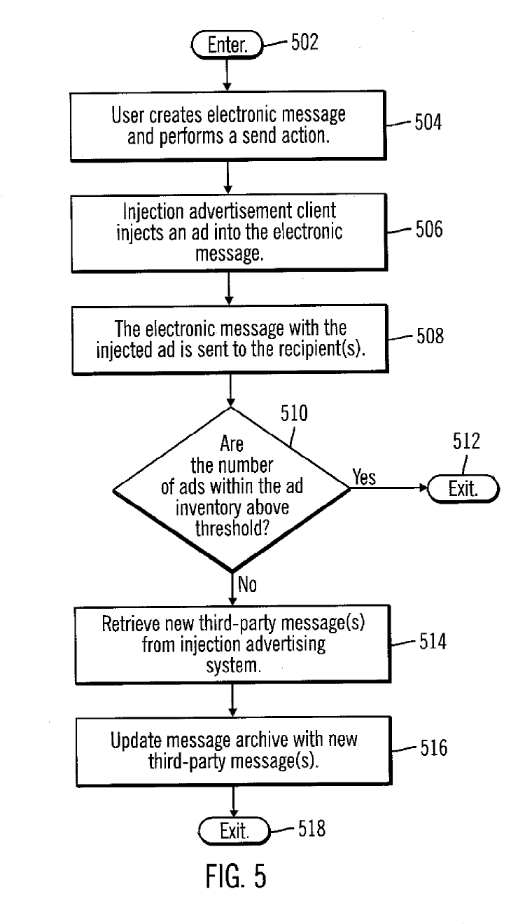

FIG. 5 is an operational flow diagram illustrating one example of injecting a third-party message in to an electronic message that is relevant to the sender of the message. The operational flow diagram of FIG. 5 begins at step 502 and flows directly to step 504. The user, at step 504, creates an electronic message and performs a send action. The injection advertising client 122, at step 506, injects a third-party message 128 from the message archive 129 into the electronic message. As discussed above, the injection advertising client 122 can also inject the third-party message prior to the user performing the send action. For example, the injection advertising client 122 can inject the third-party message 128 when the electronic message is initially created.

The electronic message comprising the embedded third-party message 128, at step 508, is sent to the designated recipient(s). In one embodiment, the injection advertising client 122 can notify that the injection advertising system 115 that the user has sent a message comprising an injected third-party message. The injection advertising system 115 can then update the account data 134 associated with the user-subscriber. This message can include an identifier for identifying the user sender and/or the third-party message that was embedded into the electronic message. The injection advertising system 115 uses this message to update accounting information 134 associated with the user for compensating the user, as discussed above. Also, the injection advertising system 115 can also use the information in this message for statistical purposes. For example, the injection advertising system 115 can monitor how often a third-party message was sent and report this back to the advertiser owning the third-party message.

In another embodiment, the injection advertising system 115 can update the account data 124 associated with the user based on the number of third-party message sent to or retrieved by the injection advertising client 115 at the user system 102. The injection advertising client 122, at step 510, determines if the number of third-party messages 128 within the message archive 129 is above a given threshold. If the result of this determination is positive, the control flow exits at step 512. If the result of this determination is negative, the injection advertising client 122, at step 514, retrieves one or more third-party messages from the injection advertisement system 115. It should be noted that the third-party messages can also be sent from the injection advertisement system 115 as compared to being downloaded from the system 115.

Alternatively, each time an electronic message is sent with an embedded third-party message, the injection advertising client 122 can automatically download one or more third-party messages. As discussed above, the new third-party messages have been selected by the injection advertising system 115 based on subscriber data 132 matching third-party message requirements. Therefore, the third-party messages are relevant to the user sender. The injection advertising client 122, at step 516, updates the message inventory 129. The control flow then exits at step 518.

Exemplary Process of Selecting Third-Party Messages to be Sent to a User-Subscriber

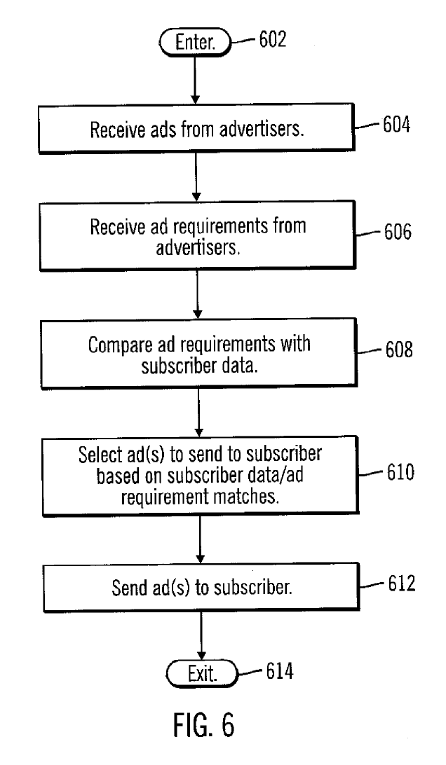

FIG. 6 is an operational flow diagram illustrating one example of selecting third-party messages to send to a user-subscriber. The operational flow diagram of FIG. 6 begins at step 602 and flows directly to step 604. The injection advertisement system 115, at step 604, receives third-party messages created by subscribing advertisers. The injection advertisement system 115, at step 606, also receives third-party message requirements such as demographics, location, categories, keywords, and the like. The injection advertisement system 115, at step 608, compares the third-party message requirements to the subscriber data 132 to identify third-party messages that are relevant to subscribers. The injection advertisement system 115, at step 610, selects third-party messages to send to subscribers based on subscriber data 132 matching or at least corresponding to ad requirements associated with and third-party message.

The injection advertisement system 115, at step 612, sends the selected third-party messages to the subscribers. For example, when an injection advertisement client 122 communicates with the system 115, it sends an identifier associated with the user. This identifier is used by the injection advertisement system 115 to identify third-party messages selected for the user. One or more of these third-party messages are then downloaded by the injection advertising client 122. Alternatively, the injection advertisement system 115 can also push third-party messages to the injection advertising client as discussed above. The control flow then exits at step 614.

Exemplary Process of Updating User Accounting Information

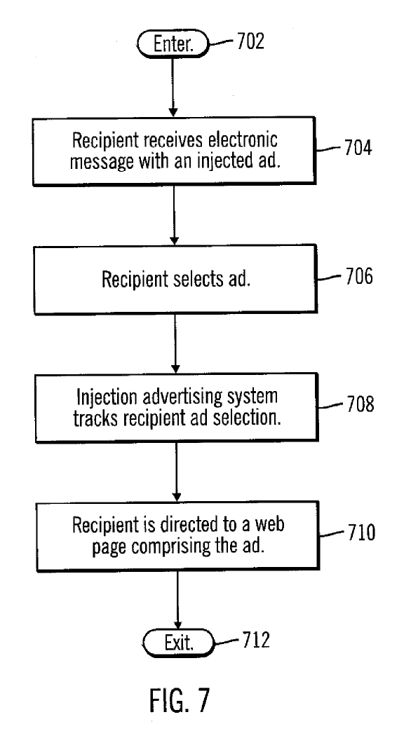

FIG. 7 is an operational flow diagram illustrating one example of updating accounting information associated with a user when a recipient of a message selects and embedded third-party message. The operational flow diagram of FIG. 7 begins at step 702 and flows directly to step 704. A recipient system 112, at step 704, receives an electronic message with an embedded third-party message 136. A recipient user, at step 706, selects the third-party message within the electronic message 136. The injection advertising system 115, at step 708, tracks this selection made by the recipient. For example, the electronic message 136, in one embodiment, comprises a hyperlink to a third-party message residing at the server 114. When a recipient selects the third-party message 128 the server detects a hit at the server 114 for the third-party message and updates the user-sender's account data 134 so the user-subscriber can be compensated accordingly. The recipient, at step 710, is then directed to a web-page at the server 114 comprising the third-party message. The control flow exits at step 710.

Overall Process of the Message Injection System

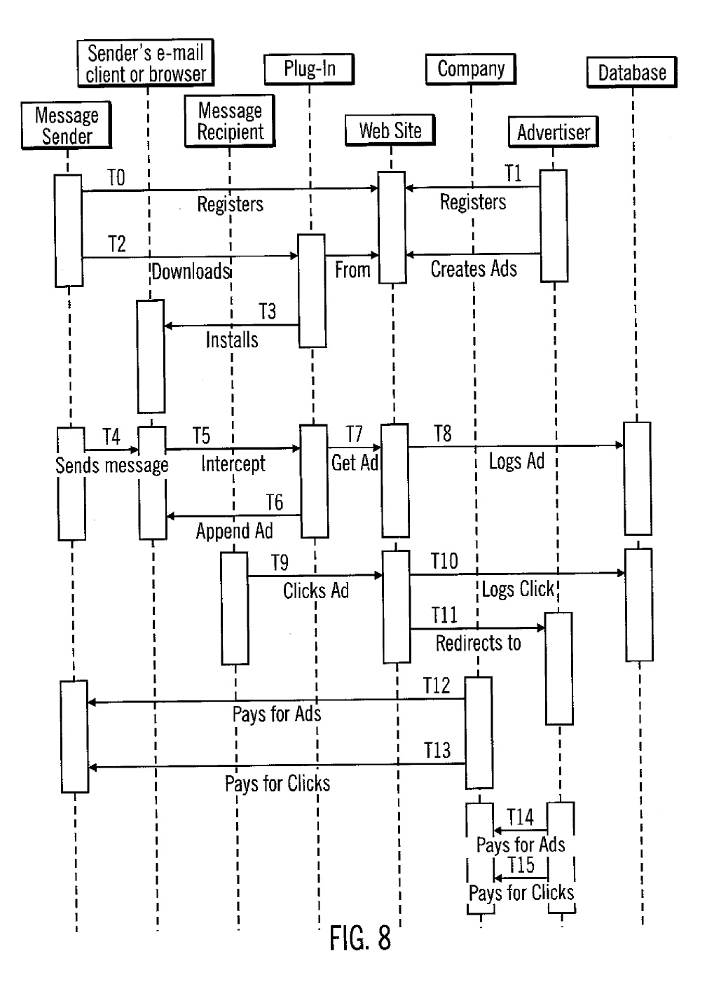

FIG. 8 is a transaction diagram illustrating an overall process of one embodiment of the present invention for providing an embedded third-party message within an electronic message. The transactional diagram of FIG. 8 begins at time T₀ and flows directly to time T₁. A user, at time T₀, registers with the injection advertising system 115 via a website. An advertiser, at time T₁, also registers with the injection advertising system 115 via a website. The user registers with the injection advertising system 115 so that he/she can send electronic messages with embedded third-party messages 128 and be compensated for doing so. An advertiser registers with the injection advertising system 115 so that its third-party messages can be embedded into electronic messages and reach a large audience.

The user, at time T₂, downloads the injection advertising client 122 from the website and installs the client 110, at time T₃. The user, at time T₄, creates an electronic message and performs a send action. It should be noted that the user is not required to register with the injection advertising system 115 in order to send electronic messages with injected third-party messages 128. When a user installs the injection advertising client 122, third-party messages are downloaded into the message archive 129. These messages can be injected into an electronic message even though the user has not registered at the system 115. However, this message may not be relevant to the sender and the sender is not compensated for sending such messages until the sender is registered.

The injection advertising client 122, at time T₅, intercepts the electronic message, and at time T₆, embeds and third-party message to the electronic message. The injection advertising client 122, at time T₇, retrieves another third-party message from the injection advertisement system 115. The injection advertisement system 115, at time T₈, updates accounting information 134 associated with the user to indicate that the user sent an email with an embedded third-party message. The recipient of the electronic message, at time T₉, clicks the third-party message within the received electronic message 136. The injection advertisement system 115, at time T₁₀, updates the accounting information 134 associated with the user to indicate that a recipient of a message has selected a third-party message within an electronic message. The recipient, at time T₁₁, is then redirected to the advertiser based on the third-party message. The user, at time T₁₂, is then paid for emails messages sent with third-party messages 128 and is also paid, at time T₁₃, for third-party messages 128 that a recipient has selected. The advertisers, at time T₁₄, pay for third-party messages that they generated at the injection advertising system 115 and also pay, at time T₁₅, for third-party messages 128 selected by a recipient of an electronic message with an embedded third-party message. Embedding Electronic Messages In A Browser-Based Email System

As described above, the present support various web-based email systems, including Yahoo!, Gmail, AOL, Hotmail and other email domains. The present invention solves the problem of embedding electronic messages in a tight security ‘sandbox’ that the browser places around the javascript code. Because there are no convenient APIs (application programming interfaces) available, the present invention provides embedding or ‘code injection’ comes through custom scripting.

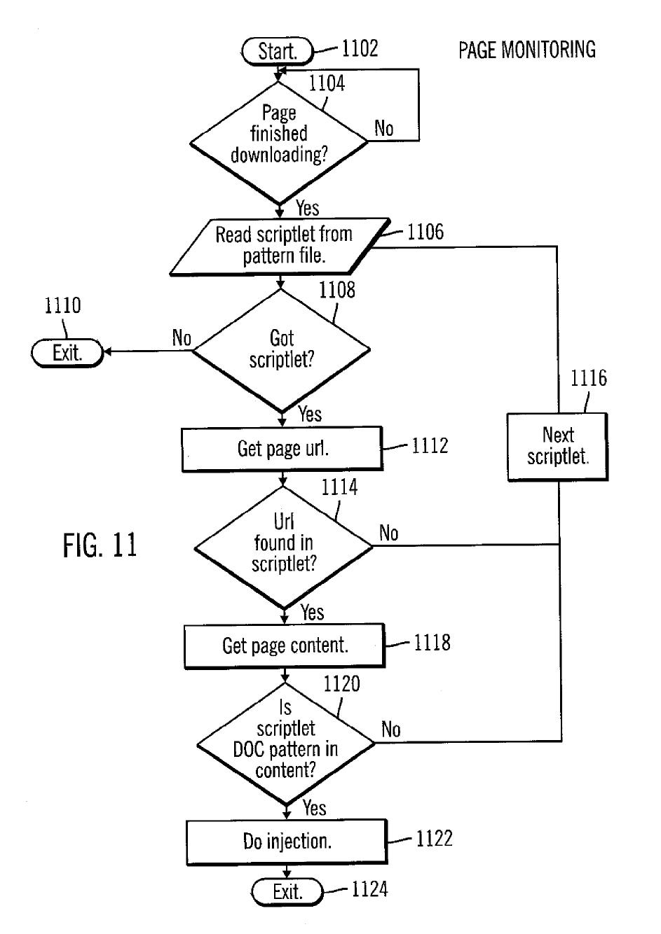

As described later with reference to FIGS. 11-14, in one embodiment, the web-based email or messaging program uses page monitoring and code injection for injecting advertisements and messages inside e-mail. Described now is a partner embodiment, where a partner or entity maintains a list of recipients to which it has permission to send messages. For example, a partner can be a retail store that maintains a list of customers. In this partner embodiment, the Message Sender in FIG. 8 is the partner. Only a sub-set of steps in FIG. 8 are required. Specifically, steps in FIG. 8 of T₀ message sender “Registers” and T₁ Advertiser “Registers are required to setup each party. In this partner embodiment, an URL with optional parameters maybe used as part of the registration process, which will be discussed in more detail below. It is important to note however that the steps of download and install i.e., steps T₂ “Downloads”and T₃ “Installs” are generally eliminated in this partner embodiment. The process of the message sender and the message being intercepted remained unchanged in this embodiment. Specially, the following steps are carried out. T₄ “sends message, T₅ “Intercept”, T₆ “Append Ad”, T₇ “Get Ad”, T₈ “Logs Ad”, T₉ “Clicks Ad”, T₁₀ “Logs Clicks” and T₁₁ “Redirects to Advertiser” are required. Further, the Advertiser pays for the ads being delivered to the message recipient and/or clicks by the message recipient on the ads in steps T₁₄ and T₁₅ “Pays for Ads” and Pays for Clicks“. In this partner embodiment, the Company which maintains the website for advertisement injection compensates the Message Sender i.e. partner for the ads being delivered to the message recipient and/or clicks by the message recipient on the ads in steps T₁₂ and T₁₃.

A non-limiting example of this partner embodiment is now described. In this example the partner is a social networking site. The social networking site sends out e-mails to its registered users regarding site enhancements. The social networking site registers with Company through the Web Site in FIG. 8. When the social networking site sends out information to its members, advertisements are automatically inserted in the e-mails to each member. The advertisement is selected based on information the social networking site provides to select the ad for each member. This information for selecting the advertisement is shared by the social networking site as part of the URL. This information shared by the social networking site can be an absolute value such as zipcode or a range of values such as age. The information can include one or more values for age, date of birth, gender, income, educations, city state, zipcode, country, area code. Still in another partner embodiment, information shared by the social networking site can be the subject of the message or even the text of the message itself, so that keywords can be compared and used to help select this message. Using the present invention, the social networking site is able to maintain control over its membership base by not sharing personally identifiable information such as an e-mail address. Therefore the social networking site maintains control over its membership. While at the same time using the present invention, the social networking site, is able to receive revenue from the targets advertisements being injected into messages it is sending. Further, the present invention requires very little change to the mail delivery systems by the partner, which will now be described.

The format of the URL used by the partner includes a server address portion followed by one or more parameters or keys used to select the advertisement.

The following are some examples:
Example I: http://injections.adpickles.com/injections?api_id=abc
This URL has the server http://injections.adpickles.com along with an identifier of the partner “abc” to filter for the correct ad.
Example II: http://injections.adpickles.com/injections?api_id=abc&from %5Bage%5D=20&to%5Bage%5D=30&from%5Bgender%5D=male
This URL has the server http://injections.adpickles.com along with an identifier of the partner “abc” and ages from 20 to 30 years old and gender is male to filter for the correct ad.
Example III: http://injections.adpickles.com/injections?api_id=abc&from%5Bage%5D =20&to%5Bage%5D=30&from%5Bdob%5D=1970&to%5Bdob%5 D=1980&from%5Bgender%5D=male&to%5Bgender%5D=female& from%5Bincome %5D=30%2C000&to%5Bincome%5D=60%2C000& from%5Beducation%5D=hs&to%5Beducation%5D=hs& from%5Bcity%5D=Orange&from%5Bstate%5 D=NJ&from%5Bzip_code%5D=07041&from%5Bcountry%5 D=Essex&from%5Barea_code%5D=201&to%5Barea_code%5D=971
This URL has the server http://injections.adpickles.com along with an identifier of the partner “abc” and ages from 30 to 60 years old and gender is male or female, high school education, city is orange, state is NJ, zipcode 07041, county is Essex and area code 201 and 971 to filter for the correct ad.

The URL used by the partner in an e-mail to embedded a message as shown above is easy to implement with little technical know how. The deployment of the URLs with one or more parameters include libraries with scripts for different type of e-mail server platforms e.g. Python, ASP, PHP, Perl, Ruby and others. For one of more popular platforms a plug-in that automatically pulls the various values to create the URLs used to select the advertisements for an e-mail is used. The parameters are pulled from a partner's site automatically.

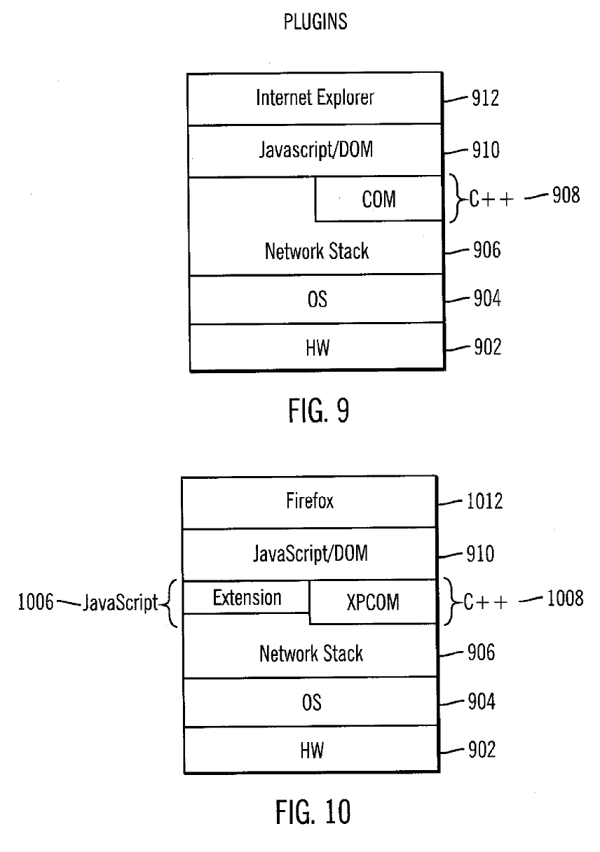

Turning now to FIGS. 9 and 10 shown are to two examples of the over-all plug-in architecture according to the present invention. It should be quickly noted that many of the components are identical across difference browsers shown here Internet Explorer FIG. 9 and Firefox of FIG. 10. For example a hardware platform 902, as previously described can be any hardware that supports a browser from PCs and Macs, to handheld devices and mobile phones. Executing on the hardware platform 902 is an operating system or OS 904 such as those available from Microsoft, Apple, Palm or based on Linux. The network stack includes communication drivers to enable a web-browser 912 Internet Explorer or Firefox 1012 to communicate over the world-wide web or internet 108 of FIG. 1. The primary difference between FIGS. 9 and 10 are the browsers and how the present invention interacts with the Javascript 910 and Document Object Model 910 of the web-page. In the Internet Explorer example a Microsoft common object model (COM) is used to a C++ program. In the Firefox example, the Javascript 910 and Document Object Model 910 of the web-page use a Javascript Extension 1006 and an XPCOM (cross-platform common object model). In a windows operating system environment, a browser help object (BHO) DLL in C++ 908 gets loaded when Internet Explorer 912 starts up. The BHO then hooks into various low-level events, such as connection/disconnection and document load. The document load event permits access to the javascript DOM 910 that corresponds to the page that the browser is loading. For more information on windows plug-ins refer to on-line URL (msdn.microsoft.com).

In a windows operating system environment, a browser such as Firefox 1012 of FIG. 10 uses an extension in javascript 910, as defined by the Mozilla API. The extension permits the hooking into the javascript of any particular web page and install event listeners for page-load. For more information on windows plug-ins refer to on-line URL (www.mozilla.org).

The goal of the plug-in is two-fold. First it must determine if a particular web page is of interest. Secondly, if it is of interest, then it must perform the actual content injection. Turning now to FIG. 11 shown is a generalized flow of the web page monitoring used in the web-based email systems. The process starts at step 1102 and immediately proceeds to a test at step 1104 to determine if the web page has finished downloading. An example web page would be Gmail at online URL (mail.google.com). The process waits for the page to complete and once the page completes a scriptletPage monitoring—the plug-in hooks into the browsers ‘page load’ mechanism and looks at every page as it comes in. It uses target pattern recognition techniques to identify target pages. A target pattern file illustrated below is maintained locally by the plug-in. This target pattern file contains unique information that can be searched for in the incoming pages, in order to determine whether or not that page is a target page or not. An XML example of a structure of the target pattern file is as follows:

<scriptletinfos>

<version></version>
<scriptletinfo>

<url_patterns>

<pattern></pattern>

...

</url_patterns>

<doc_patterns>
<pattern></pattern>

...

</doc_patterns>
<script_src></script_src>

</scriptletinfo>

...

</scriptletinfos>

The target pattern file is retrieve from local storage in step 1106. If the target pattern file is successfully retrieved the process moves on to step 1112 get page URL. In the case the target pattern file is not found the process ends at step 1110. The target pattern file includes an arbitrary number of scriptletinfo blocks, which describe a particular point of message embedding or message injection on a web-based email system. The URL in step 1112 is obtained from the downloaded page.

Next the url_patterns block are enumerated looking for a substring match of any pattern within the incoming URL. If a match is found in step 114, the process proceeds to the next half of the pattern-recognition stage to get the inner HTML text of the downloaded web page content in step 1118. This is usually available via the DOM 910. Next the pattern elements are enumerated in the doc_pattern block, looking for substring matches of those patterns within the document source in step 1120. If a match is found, the process continues to step 1122 a target page for injection and the process ends in step 1124. If no match is found the process continues looking at the next scriptlet in step 1116 until all scriptlets are used and the process either terminates in step 1110 or message injection is scheduled in block 1122. In this case, the actual javascript inject is given by a source pointer URL in the corresponding script-src block to point to the message to be embedded.

It is important to note that each scriptletinfo block is enumerated in turn for every page load. If no matches are found in any scriptletinfo's, the page is left untouched. We also obtain other important information, such as the source URL of the loading document. Using this, we determine if we are on a page that we need to inject into or not. To do this we maintain an XML file of ‘patterns’, which are basically fragments of source URLs and unique javascript code on the particular pages we are interested in. Each time a page loads, we scan the pattern file for a match and if found, we proceed with the injection. Otherwise we leave the page untouched.

The version item is used to keep the local pattern file in sync with the master file up on the messaging server 114 of FIG. 1. Each time the plug-in loads into the browser, if the version of the master file is higher than that of the local file, the local is replaced with the updated file.

The contents of the scriptletinfo blocks are discovered and maintained by hand up at the server 114 of FIG. 1 in the master pattern file (not shown). For each web-based email site or injection site, a browser DOM tools is used to analyze the HTML and javacript source of those pages, looking for id's, string fragments or anything can be used to uniquely identify a particular page. Tracking changes in 3^{rd}-party websites is as simple as updating the scriptletinfo information in the master pattern file at the server 114 of FIG. 1, which will then get automatically synced down to the browser client-side plug-ins 910 next time they run.

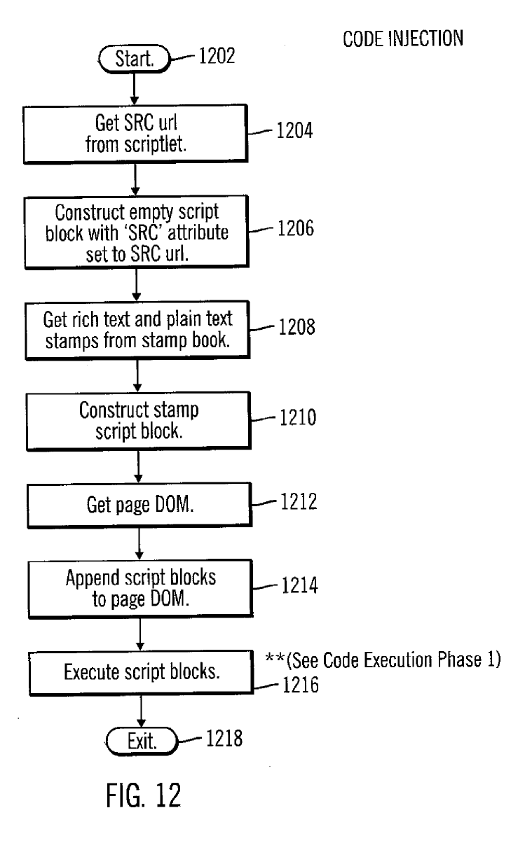

The details of message embedding and message injection are now discussed with reference to FIG. 12. Turning now to FIG. 11 shown is a generalized flow of the web page monitoring used in the web-based email systems. The process starts at step 1202 and immediately proceeds to a obtaining the source URL from the scriptlet in step 1204. The pattern file also contains URL's to javascripts that store on the server 114. This is the actual javascript to be injected or embedded. Ease of maintainability is accomplished by keeping this code on the server 114. In step 1206, the block that is embedded into a web-page are messages called stamps retrieved from the local stamp book in step 1208 and a <SCRIPT> block that references the corresponding javascript file up on the server 114. A javascript is designed for each web-based email client such as mail.yahoo.com, hotmail.com and mail.google.com. The javascripts are hand-tailored to a particular site.

After constructing the <SCRIPT> blocks in step 1210 for embedding or injection, using standard C++ DOM APIs (application programming interfaces), the live DOM object for the target web-page via the pageload event is obtained in step 1212. Next in step 1214, new DOM nodes are appended to the end of that and web-browser 912 or 1012 executes them. This is live secondary message injection into a primary email message for a web-based email system.

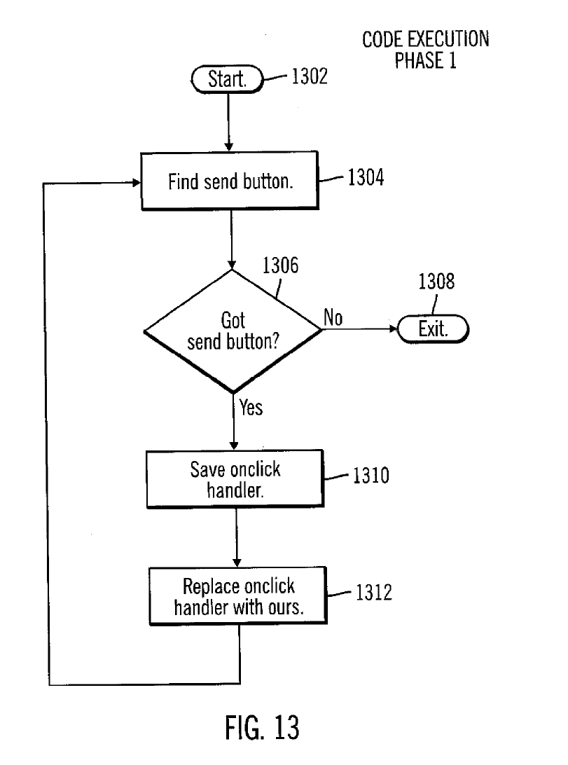

FIG. 13 is an example flow of message or code injection for a first phase of code execution, according to the present invention. The process begins at step 1302 and immediately proceeds to step 1304 of finding the send button. Once the down-loaded web-page is identified as an injection target, the javascript is dynamically injected into the downloaded page. This can only be done reliably after the page has finished downloading. Injection is achieved by using the browser DOM (Document Object Model), which is an API that describes the content of a page in terms of a hierarchy of nodes. Both browsers (IE and Firefox) allow access to a pages DOM tree. The API is used to dynamically construct two <SCRIPT> blocks and append them. This also has the effect of having them execute. Examples of the two script blocks are as follows:

<SCRIPT>var sStamp = ‘html stamp content here..’;

var sStampPT=’plaintext stamp content here..’;</SCRIPT>

Here we declare two ‘stamps’, which are the content of the Ads we are injecting, in both rich-text and plain-text formats. This content is obtained from another XML file we maintain locally called the stampbook’. The second script block we inject is as follows:
<SCRIPT src=‘url of javascript source file to inject . . . ’></SCRIPT>

The ‘src’ attribute is set to whatever the contents of the script-src block for this downloaded web page was in the pattern file (as described above). Every injection target has a different script to inject, so these scripts are maintained on the server 114 and inject SCRIPT blocks here that merely point to them.

The javascript that is injected is also maintained by hand on the server side 114. It is discovered by using browser-based DOM spy tools to examine the source of the web-based email sites. Each script file follows a similar sequence of steps:

In step 1306, the process continues by finding the element(s) corresponding to the ‘Send’ button on the particular email composition page. If a send button is found a special handler is called in step 1310 or else the process terminates in step 1308.

The override the ‘onclick’ handler for that element(s)—point it to a custom click-handler function in steps 1310 and 1312.

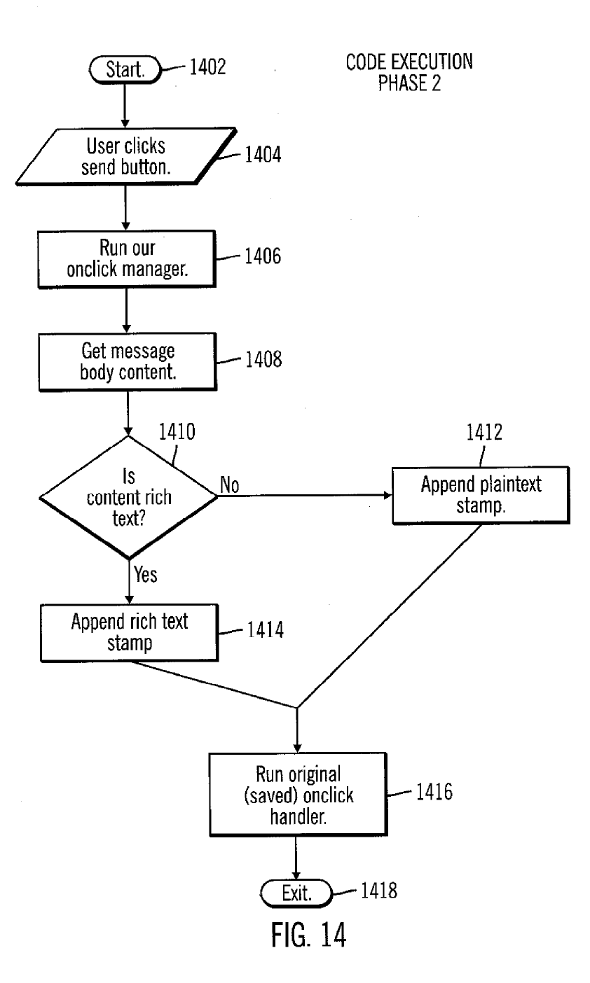

FIG. 14 is an example flow of message or code injection for a second phase of code execution, according to the present invention. Implement a click-handler function that locates the content of the outgoing email message, appends a stamp (as declared in the first script block above) and routes control back to the original click-handler so that the message gets sent as before.

The process begins on step 1402 and immediately proceeds to step 1404 where the user clicks a send button and the customer click handler 1406 is executed. The code required to achieve this set of steps is different for each website injection target.

The secondary message file or stampbook is now defined. This is a local XML file that contains the content to be injected. It is populated by an external process communicating with server 114 of FIG. 1. This process makes the HTTP calls to the server, retrieving stamps and placing them in the stampbook as needed. Note—the term ‘stamp’ is used to describe a unit of injection content, which will be an advertisement in HTML or plaintext format. Each time a stamp is injected into a page, it is removed from the stampbook file. The tray application will replenish the stampbook in the background as needed.

The format of the stampbook file is as follows:

<raw-html>

<count></count>
<default><![CDATA[ ]]></default>
<stamps>
<stamp><![CDATA[ content here.. ]]></stamp>
<stamp><![CDATA[ content here.. ]]></stamp>

...

</stamps>

</raw-html>

In step 1410 a test is made to determine whether the web-page content supports rich text. If plain text is supported the pain-text javascript is used in step 1412 and if rich text is used a rich text javascript is used in step 1414. With three additional blocks for raw-plaintext, javascript-html and javascript-plaintext. These are just additional formats of the same content, required by different browsers and email clients.

The count element is the number of stamp elements currently contained in the stamps block.

The default element is a default content item, to be used in the cases where the stampbook has run out of stamps and the tray application is unable to replenish it (possibly due to temporary loss of internet connectivity).

Each stamp element is a unit of injection content, obtained for a particular user from the server 114 via HTTP. There can be any number of stamp elements in the stamps block.

In the present invention, the local stampbook caches stamps, and thus continue stamping emails in an offline mode. It also provides a good user experience—zero delay. But most importantly it allows the current invention to overcome the security implications of cross-domain calls on a downloaded web page. When javascript runs behind a web page, it runs in a security sandbox defined by the browser. This limits the things you can do in that script. For example, accessing the local file system, or running a script that makes an http call to a server in a domain other than the one the current page belongs to. The present invention inject ads that originate from the server.com domain into arbitrary web pages that belong to other domains, for example yahoo.com. So Getting around the cross-domain security javascript sandbox in each browser is important to this technique.

In the case of Internet Explorer the BHO plug-in is implemented in C++ and thus already runs outside the security context of the javascript engine, so we can access the local file system and hence get access to our stamps for injection for Internet Explorer.

In the case of Firefox the extension is implemented in javascript and thus runs inside the browser's security sandbox. So in this case we implement an XPCOM component in C++ and access that from the javascript in the extension. This component, like the Internet Explorer BHO, runs outside of the browser's javascript sandbox, and thus provides us with a way to access the local stampbook file and pass that content safely back out to the javascript we injected into the page.

In both cases, the need for the plug-ins to make HTTP calls to retrieve content for injection has been removed and delegated to the external server calls, thus side-stepping those security issues.

The process finalized with running the original onclick handler in step 1416 before exiting in step 1418.

Further information on Firefox extensions, XPCOM components can be found at online url (http://developer.mozilla.org/en/docs/Main_Page) the teachings of which is hereby incorporated by reference in its entirety.

Further information on Internet Explorer BHO's can be found at (http://msdn2.microsoft.com/en-us/library/bb250436.aspx) the teachings of which is hereby incorporated by reference in its entirety.

Non-Limiting Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the embedded claims cover any and all such applications, modifications, and embodiments within the scope of the present invention.

What is claimed is:

1. A method for providing messaging through an electronic messaging system, the method on a client system comprising:
determining that at least one user has performed at least one of the following two acts, creating an electronic message and sending an electronic message;
selecting, in response to the determining, at least one message from a data store;
embedding the message within the electronic message; and
updating, in response to the embedding, an accounting record comprising information for compensating the user based on sent electronic messages comprising the message which has been embedded.

2. The method of claim 1, further comprising:
sending the electronic message comprising the message that has been embedded to at least one recipient.

3. The method of claim 1, wherein the message that has been embedded is a third-party message.

4. The method of claim 1, wherein the message that has been embedded is a default message.

5. The method of claim 1, further comprising:
retrieving at least one third-party message associated with the user from a remote information processing system, wherein the third-party message is associated with the user by the remote information processing system based on information in a profile associated with the user substantially matching at least one target user requirement associated with the third-party message; and
storing the third-party message in the data store.

6. The method of claim 1, wherein the electronic message is one of:
an email message;
an instant message;
a text message; and
a multimedia message.

7. The method of claim 1, wherein the message that has been embedded is an advertisement.

8. The method of claim 1, wherein the message that has been embedded includes at least a hyperlink.

9. The method of claim 1, further comprising:
installing an add-on software application communicatively coupled to the electronic messaging system for embedding the message within the electronic message.

10. The method of claim 1, wherein the information for compensating is for compensation of at least one of a monetary award and a non-monetary award.

11. The method of claim 1, further comprising:
determining that a total number of messages in the data store are below a given threshold; and
retrieving at least one new message from a remote server.

12. A method for providing third-party messages in electronic messages, the method on a server system comprising:
analyzing a profile associated with a user;
comparing information within the profile to a set of target user requirements associated with a plurality of third-party messages;
associating, in response to the comparing, at least one third-party message in the plurality of third-party messages to the user in response to at least one target user requirement associated with the third-party message substantially matching information within the profile; and
crediting an account associated with the user for compensating the user in response to a client system associated with the user utilizing the third-party message that has been associated with the user.

13. The method of claim 12, wherein the client system utilizing the third-party message comprises at least one of:
storing the third-party message associated with the user in a data store;
retrieving the third-party message from the server system; and
sending an electronic message comprising the third-party message embedded therein.

14. The method of claim 12, further comprising:
determining that a recipient of the electronic message comprising the third-party has at least one of selected and viewed the third-party message; and
crediting, in response to the determining, the account associated with the user to reflect that the recipient has selected to the third-party message.

15. The method of claim 12, further comprising:
determining that an additional user associated with the user has sent an electronic message comprising an embedded third-party message; and
crediting, in response to the determining, at least the account associated with the user for compensating the user in response to the additional user sending electronic message comprising the embedded third-party message.

16. The method of claim 12, further comprising:
receiving the plurality of third-party messages from a plurality of advertisers;
maintaining a total count of third-party messages associated with each advertiser; and
decrementing the total count in response to a third party message being at least one of downloaded and sent to a client system.

17. An information processing system for providing messaging through an electronic messaging system, the information processing system comprising:
a processor;
a memory communicatively coupled to the memory; and
an injection advertising client communicatively coupled to the processor and the memory, wherein the injection advertising client is adapted to:
determine that at least one user has performed at least one of the following two acts, creating an electronic message and sending an electronic message;
select at least one message from a data store;
embed the message within the electronic message; and
update an accounting record comprising information for compensating the user based on sent electronic messages comprising the message which has been embedded.

18. The information processing system of claim 17, wherein the injection advertising client is further adapted to:
retrieve at least one third-party message associated with the user from a remote information processing system, wherein the third-party message is associated with the user by the remote information processing system based on information in a profile associated with the user substantially matching at least one target user requirement associated with the third-party message; and
store the third-party message in the data store.

19. The information processing system of claim 17, wherein the injection advertising client is further adapted to install an add-on software application communicatively coupled to the electronic messaging system for embedding the message within the electronic message.

20. The information processing system of claim 17, wherein the injection advertising client is further adapted to:
determining that a total number of messages in the data store are below a given threshold; and
retrieving at least one new message from a remote server.

21. A method for embedding electronic messages in a browser-based email system, the method in a web-browser comprising:
executing a browser-based email system on a client system;
executing a plug-in for a web browser wherein in the plug-in performs
reading a target pattern from a file, in response to a web-page download from the browser-based email system;
determining if a web-page pattern in the web-page download from the browser-based email system matches the target pattern;
retrieving a source address of in the web-page download, in response to the web-pattern matching the target pattern, performing the following:
constructing a script block with at least one additional message source pointer;
retrieving document object model for the web-page download;
appending the script block to the document object model; and
executing at least one script, in response to send button on the web-page download being selected so as to embed the at least one additional message retrieved by the source pointer within a primary electronic message which is constructed using the browser-based email system.
